(19) United States
(12) Patent Application Publication
(10) Pub. No.: US 2003/0053530 A1
(43) Pub. Date: Mar. 20, 2003

(54) Communication control method

(75) Inventors: Nobuhiko Noma, Yokohama-shi (JP); Keiichi Tomita, Yokohama-shi (JP); Tatsuo Imai, Chigasaki-shi (JP)

Correspondence Address: GREENBLUM & BERNSTEIN, P.L.C., 1950 ROLAND CLARKE PLACE, RESTON, VA, 20191, US

(73) Assignee: MATSUSHITA GRAPHIC COMMUNICATION SYSTEMS, INC., Tokyo (JP)

(21) Appl. No.: 10/126,680

(22) Filed: Apr. 22, 2002

(30) Foreign Application Priority Data
Sep. 14, 2001 (JP) P2001-279555

(51) Int. Cl. H04B 1/38; H04L 5/16

(52) U.S. Cl. 375/220; 375/222

(57) ABSTRACT

A center and remote sides are connected via a line and perform an initialization sequence to set a transmission speed and to detect gain characteristics of a signal received during the initialization sequence at both sides. Both center and remote sides then inform each other of the detected gain characteristics and correct gain characteristics of future transmission signals based on the informed gain characteristics. Therefore, it is possible for a sender side to perform a gain correction that raises gain amounts of transmission signals according to a decay rate, and for a receiver side to maintain the reception level, which is more than a predetermined value, thereby providing a high-speed data rate.

### BACKGROUND OF THE INVENTION

1. Field of the Invention

This invention relates to a communication control apparatus employing an xDSL technology that enables a high-speed communication of several M bits/second even when a copper wire cable is used for the subscriber line. This invention especially relates to an ADSL communication control method, communication control apparatus, and ADSL communication apparatus that starts a data communication after performing initialization steps and parameter setting that is optimal for the line conditions.

2. Description of Related Art

With the widespread use of the Internet, there is a high demand for a high-speed access line that can be used for a permanent connection. Optical fiber is becoming more popular in the backbone of communication industries, and gigabit class super high-speed line is starting to be employed in the key components of the backbone. However, most of the subscriber lines that connect user's home and storage centers of the communication industries are copper wire cables that are constructed for telephones. Therefore, an introduction of the xDSL technology that enables a high-speed communication of several M bits/second with a copper wire cable has been considered.

ADSL method is one aspect of the xDSL technology. The ADSL method uses much higher carrier frequency range of more than 35 kHz compared the range used for telephones (less than 4 kHz). Therefore, high-speed data communication can be performed using a telephone line, without hindering telephone functions.

FIG. 9 is a schematic illustration of a system configuration of a subscriber side. The storage center of a communication industry (center side) transmits signals to line 1. User's home (remote side) splits received signals from line 1 at splitter 2, inputting voice range signals (less than 4 kHz) into a telephone (POTS: Plain Old Telephone Service) 3, and high range signals (more than 35 kHz) into ADSL communication apparatus 4. ADSL communication apparatus 4 includes ADSL modem 5 and controller 6. Controller 6 controls data transmission/reception with data communication apparatus 7 (e.g., personal computer) and performs an initialization control for ADSL modem 5.

FIGS. 10 and 11 illustrate initialization sequence that is performed at ADSL modem 5 based on the ITU-T recommended G.992.1. In the example of FIG. 10, the control is arranged to perform a handshake step by ADSL modem 5, based on the ITU-T recommended G.994.1, prior to performing an initialization sequence.

In an initialization sequence based on the ITU-T recommended G.992.1, the center side transmits C-RATES1 and C-MSG1 to the remote side as the first negotiation, informing a general transmission speed for the downlink and uplink and additive information. In response, the remote side transmits R-RATES1 and R-MSG1 to the center side, informing the remote side's transmission speed and additive information.

After the first negotiation, both center and remote sides transmit C-MEDLEY and R-MEDLEY that are training signals, so that both center and remote sides check the reception conditions and determine carriers for carrier-off and bit number used for each carrier. As a second negotiation, the remote side transmits R-RATES and R-MSG to the center side, informing the center side of the remote side's capacity information and information regarding the reception conditions (e.g., S/N). The center side determines detail information (transmission speeds for uplink and downlink) and capacity information based on the reception result of R-MEDLEY, and transmits C-RATES and C-MSG to the remote side to inform the center side's capacity information and detail information regarding the reception conditions.

After the second negotiation, the remote side determines the remote side's capacity information and transmission speeds for uplink and downlink, based on the capacity information and transmission speeds for uplink and downlink received from the center side at the second negotiation. As a third negotiation, the remote side transmits R-RATES2 and R-MSG2 to the center side, informing the capacity information and transmission speeds for uplink and downlink decided at the remote side. Upon receiving R-RATES2 and R-MSG2 from the remote side, the center side transmits the information with the same content as C-RATES2 and C-MSG2 to the remote side, if there is no change in the capacity information and transmission speeds for uplink and downlink decided at the second negotiation. And the center side declares that the communication will be performed with the capacity information, transmission speeds for uplink and downlink, and additive information determined by the center side.

Lastly, the center side transmits the capacity information, transmission speeds for uplink and downlink, and additive information declared at the third negotiation as C-B&G to the remote side. The remote side transmits the capacity information, transmission speeds for uplink and downlink, and additive information instructed by the center side as R-B&G to the center side.

As described above, the center and remote sides perform three negotiations, and finally exchanges carrier number for carrier-off, bit allocation for each carrier to be used, and B&G that sets gain information for the carrier to be used, in order to complete the initialization sequence. Upon normally completing the initialization sequence, the data communication begins (SHOWTIME).

However, the above-described ADSL communication apparatus uses frequency band from about 10 kHz to 1 M kHz range. Since a decay rate for a higher frequency band is high, a signal distance range is severely affected, which has been an obstacle to provide a high-speed data rate.

### SUMMARY OF THE INVENTION

The present invention addresses the above-described problems. The object of the invention is to provide a communication control method, communication control apparatus, and ADSL communication apparatus that are able to extend a signal distance range even with the high decay rate in the higher frequency band and provide a high-speed data rate.

This invention detects gain characteristics of a signal received during an initialization sequence, informs each other of the detected gain characteristics, and correct the gain characteristics of the future transmission signals based on the gain characteristics informed by the partner communication control apparatus.

### BRIEF DESCRIPTION OF THE DRAWINGS

The present invention is further described in the detailed description which follows, with reference to the noted plurality of drawings by way of non-limiting examples of exemplary embodiments of the present invention, in which like reference numerals represent similar parts throughout the several views of the drawings, and wherein:

FIG. 1 is a sequence chart illustrating an initialization sequence of original procedure performed according to an embodiment of the present invention.

FIG. 2 is a flowchart of a handshake step performed by a remote side according to the embodiment.

FIG. 3 illustrates a field configuration of a mode select signal used according to the embodiment.

FIG. 4(a) illustrates a downlink reception spectrum before a gain correction.

FIG. 4(b) illustrates an uplink reception spectrum before a gain correction.

FIG. 5(a) illustrates a downlink transmission spectrum after a gain correction.

FIG. 5(b) illustrates an uplink transmission spectrum after a gain correction.

FIG. 6(a) illustrates a downlink reception spectrum after a gain correction.

FIG. 6(b) illustrates an uplink reception spectrum after a gain correction.

FIG. 7(a) is a signal configuration of C-RATE1 transmitted to the remote side according to the embodiment.

FIG. 7(b) is a signal configuration of R-RATE1 transmitted to the center side according to the embodiment.

FIG. 8 is a partial functional block diagram of an ADSL communication apparatus according to the embodiment.

FIG. 9 is a schematic system configuration of the remote side.

FIG. 10 is a first half of the initialization sequence based on ITU-T recommended G.992.1.

FIG. 11 is a second half of the initialization sequence based on ITU-T recommended G.992.1.

### DETAILED DESCRIPTION OF PREFERRED EMBODIMENTS

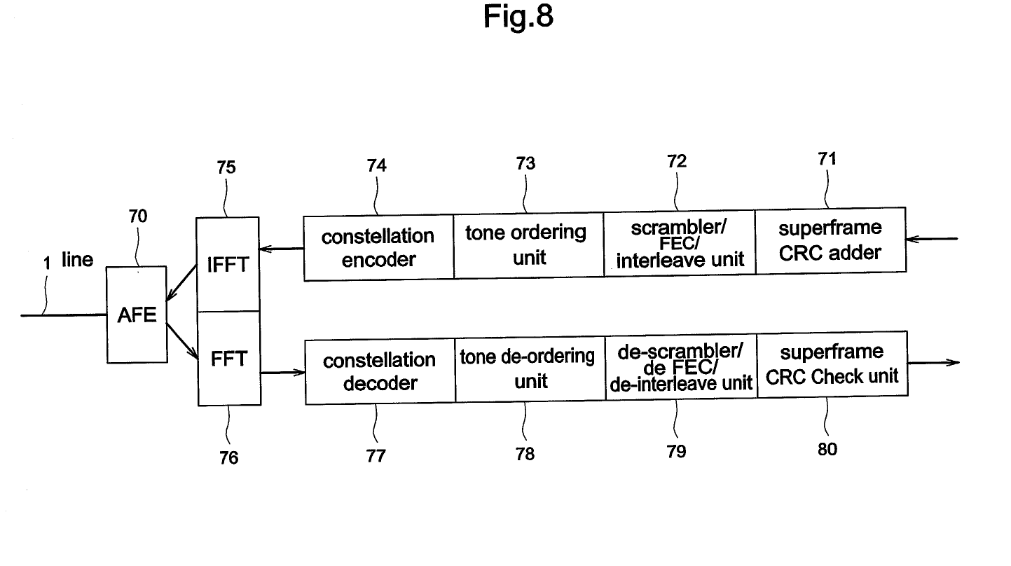

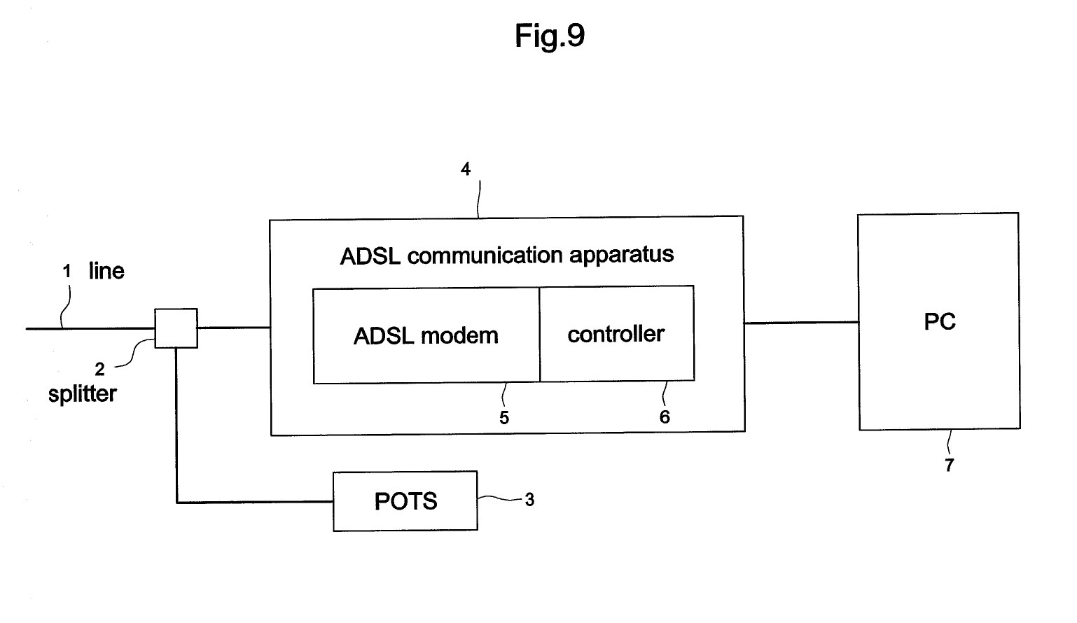

The embodiment of the present invention applied to an ADSL communication apparatus is explained in the following, in reference to the above-described drawings. ADSL communication apparatuses placed in a center side and in a remote side, as shown FIG. 9, consist of an ADSL communication modem 5 and a controller 6. Further, the ADSL communication apparatus shown in FIG. 9 is connected to a splitter 2 and POTS 3 since the ADSL communication apparatus in the remote side, which is mainly placed in a home, is shown. However, unnecessary devices in the center side can be deleted. The ADSL modem 5 includes DSP which performs a handshake procedure, an original procedure and an initialization sequence. These procedures will be described later. When the handshake procedure, the original procedure or the initialization sequence is performed, the DSP analyzes a FFT output signal output from a FFT 76 shown FIG. 8, generates a signal defined by a standard, or the original procedure to output to an IFFT 75.

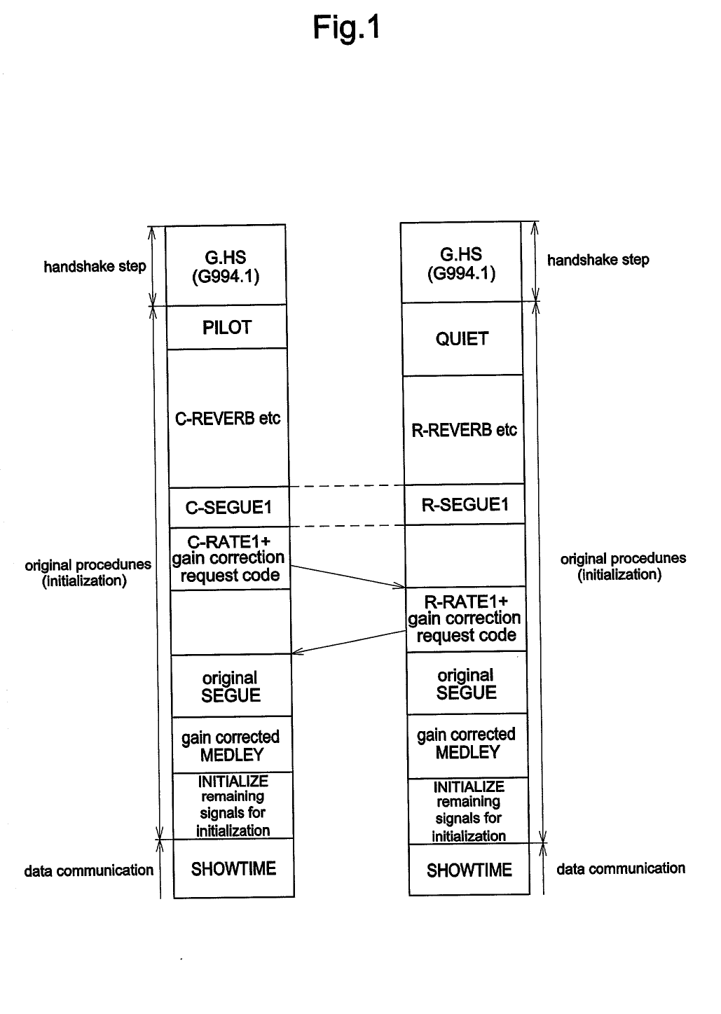

FIG. 1 illustrates a handshake step and initialization sequence performed between the center and remote sides. The center and remote sides separately have ADSL communication apparatuses that are able to perform the sequence of FIG. 1.

When the ADSL communication apparatus at the remote side is turned on, the ADSL communication apparatus sends a connection request to the ADSL communication apparatus at the center side, so that the line between the remote and center sides is connected. In this embodiment, the ADSL communication apparatus at the center side is always ready to reply to the remote side's connection request.

When the line is established between the remote and center sides, a handshake step is performed. FIG. 1 illustrates a handshake step based on the ITU-T recommended G.994.1. In the present embodiment, the handshake step checks whether the opposite apparatus is capable of performing original procedure. If the opposite apparatus is capable of performing the original procedure, the original procedure adding a gain correction is performed during the initialization sequence.

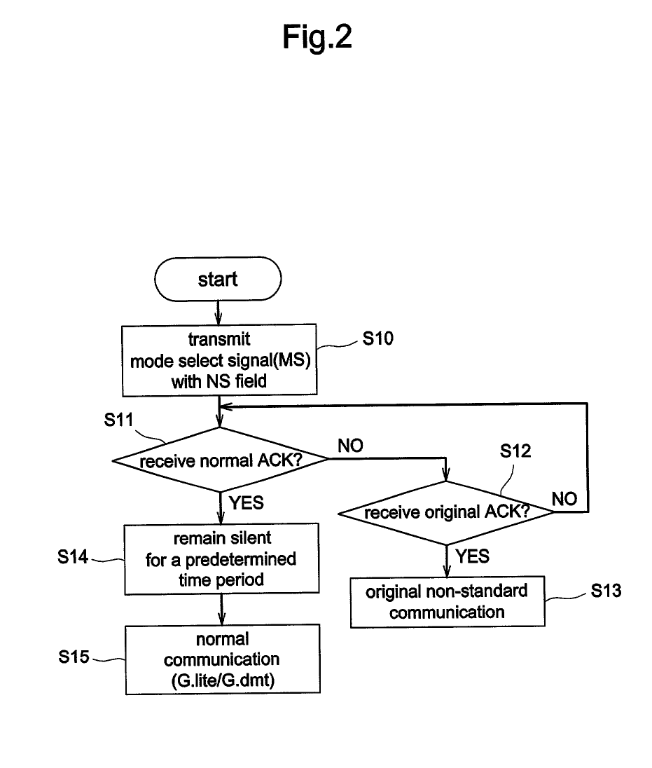

FIG. 2 is a flowchart for the remote side to determine whether the original procedure is possible during the handshake step. The remote side transmits a mode select signal (MS) with NS (Non-Standard Information) field to the center side (Step 10).

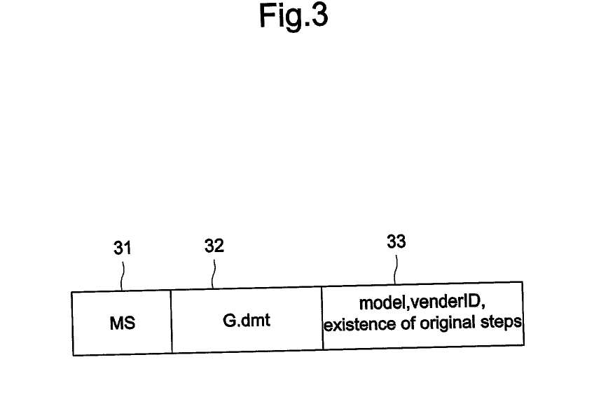

FIG. 3 illustrates a field configuration of the mode select signal (MS). As shown in figure, the mode select signal (MS) is provided with identification field 31, standard information field 32, and non-standard information field 33. In identification field 31, a command regulating the whole features of the handshake step is set. The example in FIG. 3 shows that the command “MS” stating that it is a mode select signal is set. In standard information field 32, standard information such as the initialization sequence and communication method used for the data communication is set. For example, when identification information field 31 sets “MS”, standard information field 32 sets “G.dmt”, and non-standard information 33 is not included, the initialization sequence and data communication is arranged to perform based on the ITU-T recommended G.dmt. Non-standard information field 33 is a field that a maker can set their original information. In this embodiment, vender ID, modem model, information whether the original procedure are available, and the content of the original procedure are set to inform that the remote side is capable of performing the original procedure. The invention is not limited to the above information as long as the information set in non-standard information field 33 is capable of informing the partner that the apparatus can perform original procedure of the later-described gain correction.

There are situations in which the center side model can or cannot analyze and recognize non-standard information field 33 of the mode select signal transmitted by the remote side. In this embodiment, if the center side model is capable of analyzing non-standard information field 33 and recognizing the information, it is considered that the original procedure shown in FIG. 1 can be performed.

When the center side model is capable of analyzing non-standard information field 33 and recognizing the information, the center side transmits an original ACK to the remote side to inform that the original procedure can be performed. If non-standard information field 33 cannot be recognized, a normal ACK (ACK according to the ITU-T recommendation) corresponding to identification field 31 and standard information field 32 is transmitted to the remote side.

The remote side analyzes the ACK received from the center side and checks whether it is a normal ACK (Step 11). If it is not a normal ACK, the remote side checks whether it is an original ACK (Step 12). If it is an original ACK sent from the center side, the initialization according to the original procedure shown in FIG. 1 is performed (Step 13).

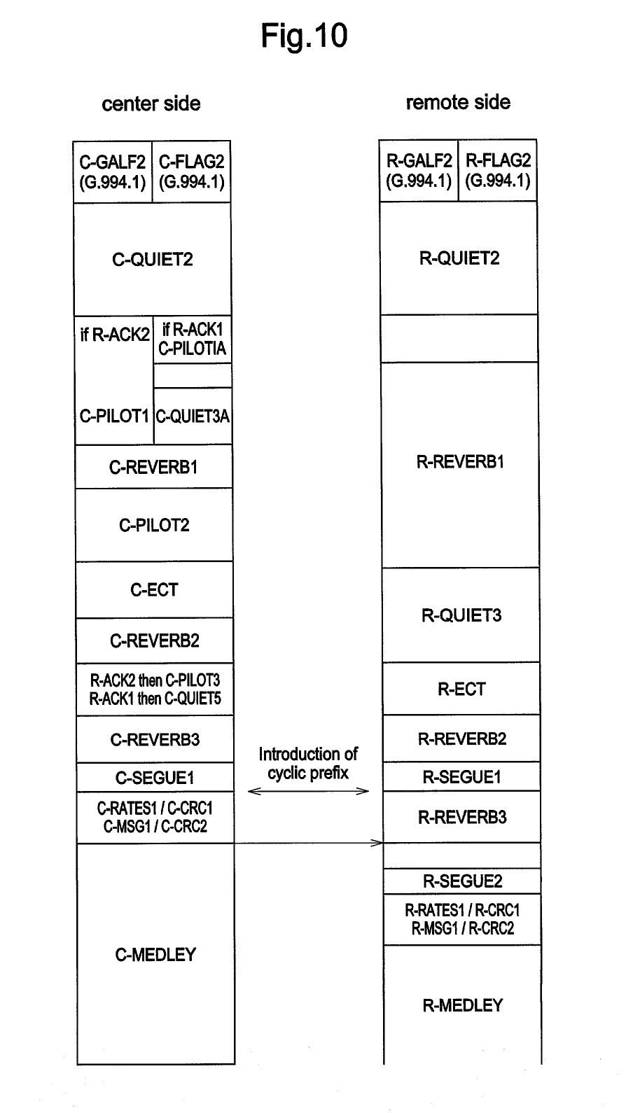

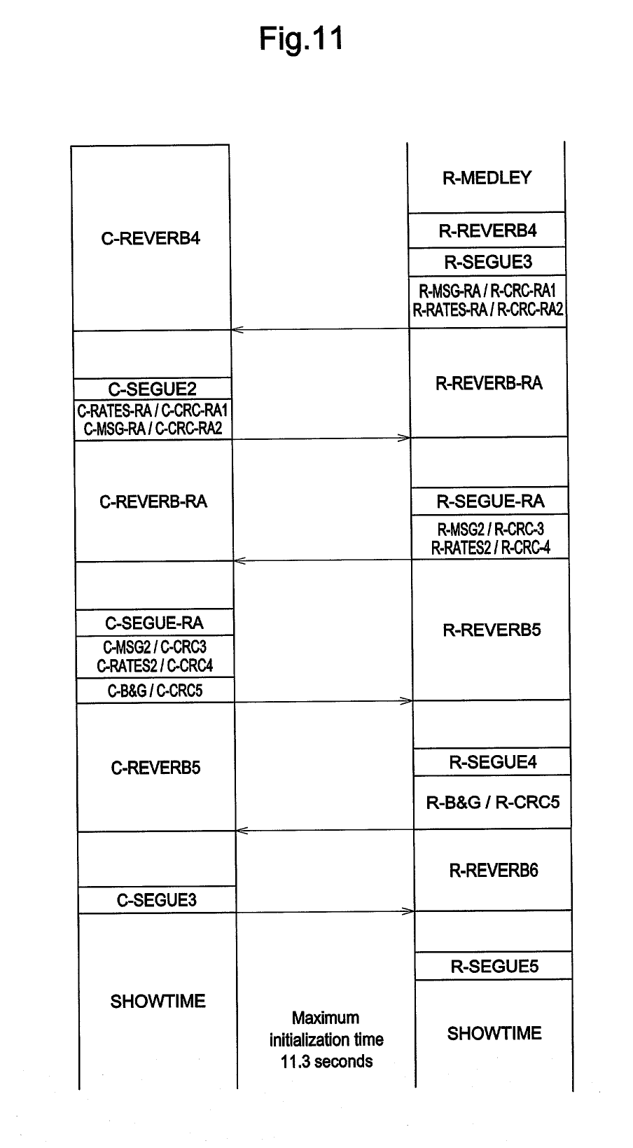

When it is a normal ACK sent from the center side, the remote side remains silent for a predetermined time period without performing the original procedure (Step 14), and performs the initialization sequence according to the ITU-T recommendation as shown in FIGS. 10 and 11 for example (Step 15).

Accordingly, during the handshake step performed prior to the initialization sequence, whether the partner model is capable of performing the original procedure is checked. Therefore, it is possible to make a transition to the standard initialization sequence when the partner model cannot perform the original procedure, thereby preventing to perform unnecessary procedure.

Next, an initializing sequence for performing an original non-standard communication (original procedure) at Step 13 is illustrated using FIG. 1. Upon confirming that both center and remote sides will perform the above-described original procedure at the handshake step, the center side transmits a REVERB signal (C-REVERB) after transmitting PILOT. The remote side transmits a REVERB signal (R-REVERB) after a period of QUIET.

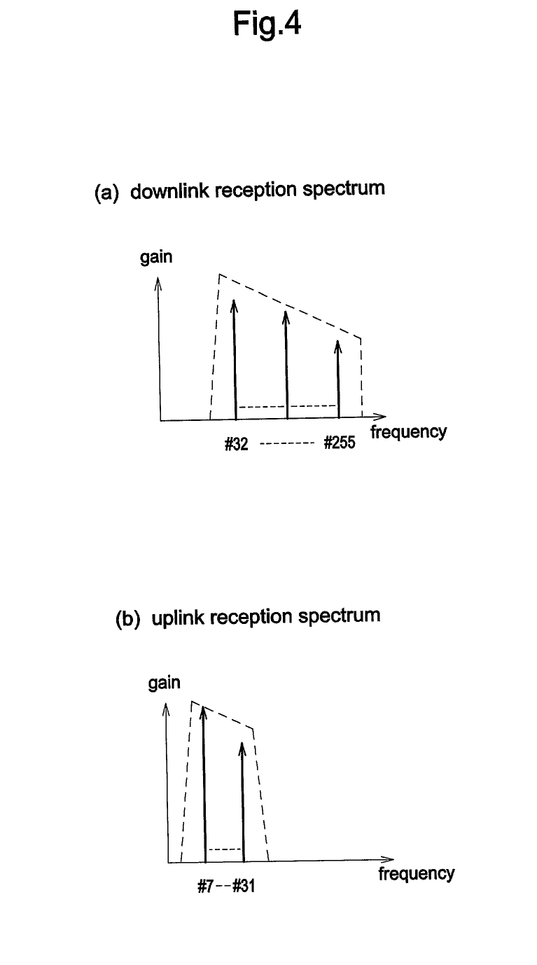

Hereafter, a concept of gain correction performed in the original procedure is illustrated referring to FIGS. 4-6.

FIG. 4 illustrates downlink and uplink reception spectrums of REVERB signals. In FIG. 4, #N (N=7-255) stands for a sub-carrier number. FIG. 4(a) illustrates a downlink reception spectrum of REVERB signals received at the center side. The downlink uses a high frequency range thus has lower gain levels in general. Especially in the high frequency range with the higher sub-carrier numbers, the gain levels are remarkably lowered. FIG. 4(b) illustrates an uplink reception spectrum of REVERB signals received at the remote side. As shown with the sub-carrier numbers, since the uplink uses a low frequency range, the gain levels are not lowered as much as for the downlink. However, the gain levels are still lowered in the higher sub-carrier numbers.

Therefore, the gain amounts of the transmission carriers are raised from the normal values at the sender side before the transmission, so that the reception level at the receiver side falls in the allowable range even with a carrier decay in the transmission path.

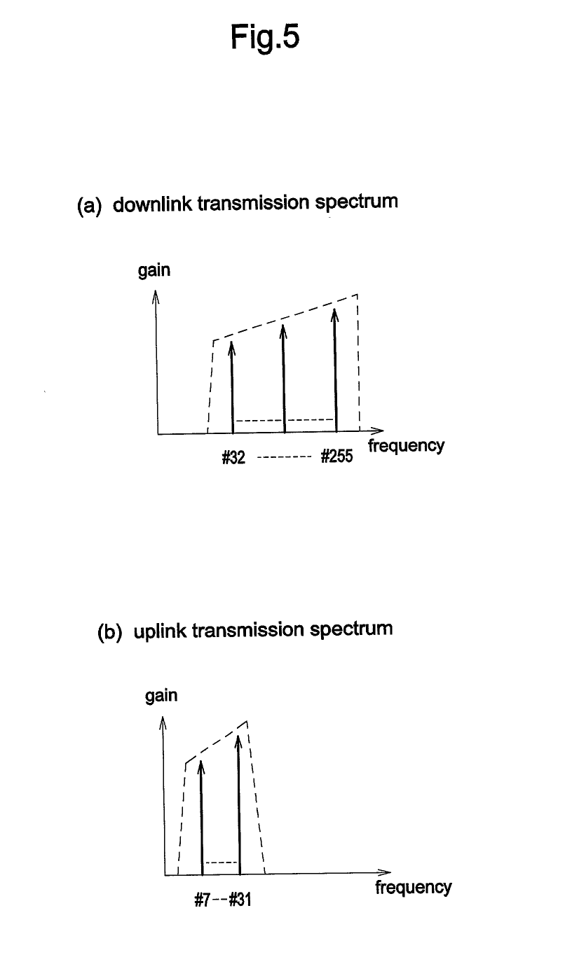

FIG. 5 illustrates downlink and uplink transmission spectrums with a gain correction for each carrier. FIG. 5(a) illustrates a downlink transmission spectrum of transmission signals transmitted from the center side. Contrary to the downlink reception spectrum shown in FIG. 4(a), gain amount of the transmission signals are gradually raised from a lower frequency side (#32) to a higher frequency side (#255). FIG. 5(b) illustrates an uplink transmission spectrum of transmission signals transmitted from the remote side. Contrary to the uplink reception spectrum shown in FIG. 4(b), gain amount of the transmission signals are gradually raised from a lower frequency side (#7) to a higher frequency side (#31). Accordingly, for both uplink and downlink, gain correction values factoring in the decay at the transmission path are added to the transmission signals before the transmission.

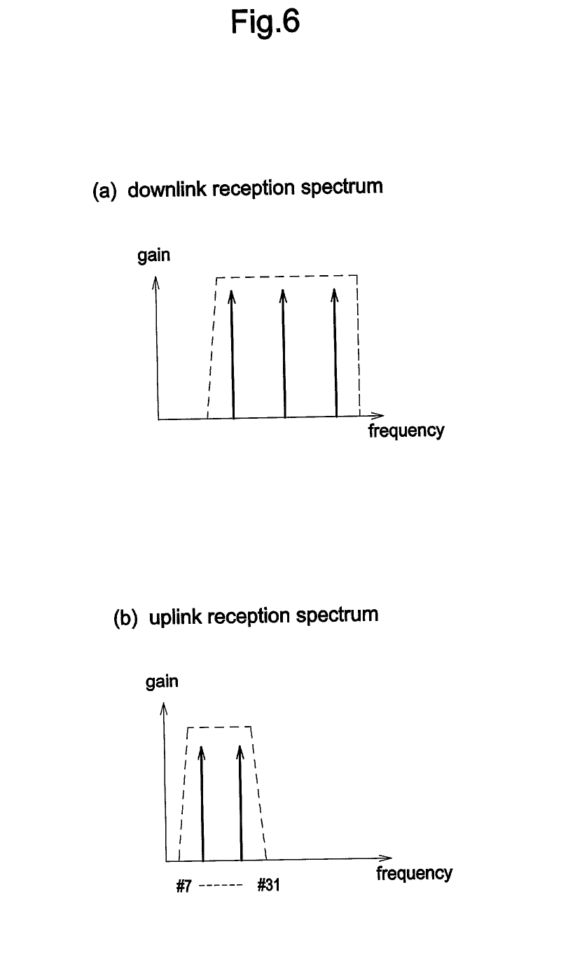

FIG. 6 illustrates a reception spectrum when sender side transmits the transmission signals with the transmissions spectrum shown in FIG. 5 and the receiver side receives the transmission signals. FIG. 6(a) is a downlink reception spectrum, and FIG. 6(b) is an uplink reception spectrum. For both uplink and downlink, since gain correction values factoring in the decay at the transmission path are added to the transmission signals before the transmission, the receiver side has a reception spectrum with an apparent decreased decay effect as shown in FIGS. 6(a) and (b). In order to have the reception spectrum shown in FIGS. 6(a) and (b), the receiver side detects the gain characteristics of each carrier and informs the sender side of the detected gain characteristics to be used for the gain correction at the transmission in this embodiment. In this embodiment, “gain correction” is a concept that includes the decay rate that is directly measured at the receiver side, the gain correction value that is finally used for the gain correction at the sender side, or intermediate data during the process of converting the decay rate that is directly measured at the receiver side into the gain correction value that is finally used for the gain correction at the sender side.

In the present embodiment, the remote side measures each carrier (#32-#255) level that configures C-REVERB received from the center side, and detects and stores the carrier with the highest level (highest value) chosen from carriers #32-#255. Further, the difference between the stored highest level and each carrier level is calculated and stored. Similar to the remote side, the center side measures each carrier (#7-#31) level that configures R-REVERB received from the remote side, and detects and stores the carrier with the highest level (highest value) chosen from carriers #7-#31. Further, the difference between the stored highest level and each carrier level is calculated and stored.

The center side converts the “difference” stored for each uplink carrier (#7-#31) into decibel data showing the gain correction value of each carrier (#7-#31), and represents each of them by 4 bits. For example, if the gain correction value illustrated in 4 bit is “0000”, the gain correction is raised by 0 dB, if “0001”, it is raised by 1 dB, “0010” is 2 dB, . . . , “1111” is 15 dB. If the difference is directly calculated with decibel data, the above decibel conversion is not necessary. The remote side also converts the difference stored for each downlink carrier (#32-#255) into decibel data showing the gain correction value of each carrier (#32-#255), and represents each of them by 4 bits.

Next, the center and remote sides exchange REVERB signals (C-REVERB and R-REVERB), and transmits SEGUE signals (C-SEGUE1 and R-SEGUE1) from both sides to terminate the REVERB signals.

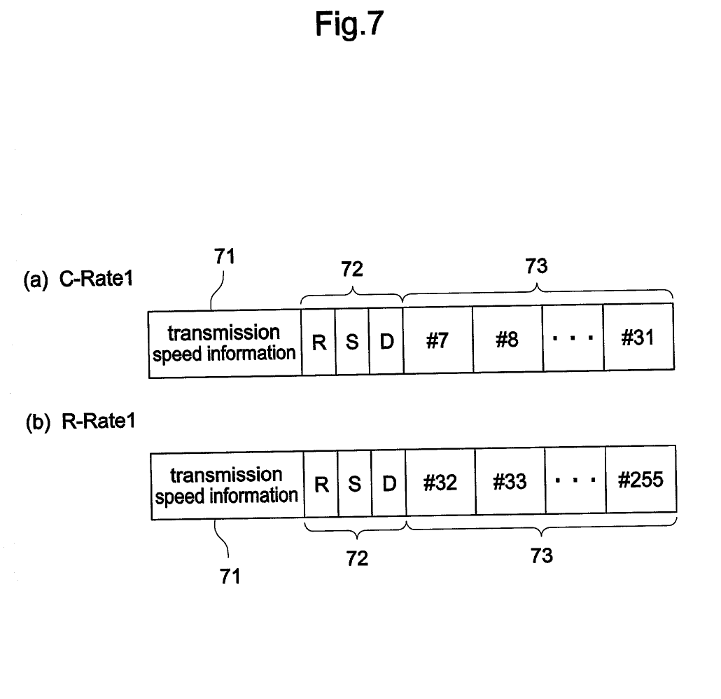

Subsequently, gain correction request code for every carrier (#7-#31) is added after C-RATE1 to be transmitted from the center side to the remote side. FIG. 7(a) illustrates a signal configuration with the gain correction request code. As shown in FIG. 7(a), the signals are configured with transmission speed information 71, parameter information (“R”, “S”, and “D”) 72, and gain correction value 73 for each carrier, which becomes a gain correction request code. Gain correction value 73 is also gain characteristics.

In addition, parameter “R” illustrates what byte Reed-Solomon code can be added, parameter “S” illustrates per what byte Reed-Solomon can be added, and parameter “D” is how deep interleave can be performed.

Such C-RATE1 signal with the gain correction request code is transmitted from the center side to the remote side so that C-RATE1 can instruct for transmission speed and parameters, and the gain correction request code can request the remote side for a signal corrected by the gain correction value of each uplink carrier (#7-#31).

Also, upon receiving the signal C-RATE1 with the gain correction request code from the center side, the remote side recognizes that the center side is requesting a gain correction of a carrier transmitted by the remote side. Then, the remote side also requests a gain correction of a carrier transmitted by the center side. FIG. 7(b) illustrates a signal configuration of R-RATE1 with the gain correction request code transmitted from the remote side to the center side.

Such R-RATE1 signal with the gain correction request code is transmitted from the remote side to the center side so that R-RATE1 can instruct for transmission speed and parameters, and the gain correction request code can request the center side for a signal corrected by the gain correction value of each downlink carrier (#32-#255).

Next, upon receiving R-RATE1 signal with the gain correction request code from the remote side, the center side transmits an original SEGUE signal (not SEGUE signal of the ITU-T recommendation) and MEDLEY signal with the gain correction to the remote side. The MEDLEY signal transmitted at this stage has the increasing gain correction with the gain correction value previously requested by the remote side regarding the carriers of #32-#255. Therefore, MEDLEY signals with a climbing transmission spectrum similar to FIG. 5(a) are transmitted, and MEDLEY signals with the flat reception spectrum similar to Fit. 6(a) can be received at the remote side.

Upon transmitting R-RATE1 signal with the gain correction request code to the center side, the remote side transmits the original SEGUE signal and a MEDLEY signal with the gain correction to the center side. The MEDLEY signal transmitted at this stage has the increasing gain correction with the gain correction value previously requested by the center side regarding the carriers of #7-#31. Therefore, MEDLEY signals with a climbing transmission spectrum similar to FIG. 5(b) are transmitted, and MEDLEY signals with the flat reception spectrum similar to Fit. 6(b) can be received at the center side.

Accordingly, both center and remote sides are informed of the decay rate of the signals transmitted by themselves. Since the decay rate is notified to the sender side as a gain correction value to increase the gain, the sender side applies the requested gain correction value to each carrier to increase the gain. Therefore, it is possible to extend the signal range and achieve a faster data rate.

Upon receiving MEDLEY signals with gain corrections, both center and remote sides perform the remaining initializing sequence set by the ITU-T recommendation. For example, if it is agreed to perform a data communication using the ITU-T recommended G.992.1 at the handshake step, processes after C-MEDLEY and R-MEDLEY in FIGS. 10 and 11 are performed. At this time, each carrier is corrected by the gain correction value set by the above original procedure. Then, from the reception result of C-MEDLEY and R-MEDLEY after the gain correction, B&G is decided and the transmission speed is set, in which a preferable result can be obtained even in the line with high frequency range.

Since uplink and downlink gain correction values are determined based on the reception results of REVERB signals, and B&G is determined based on the reception results of MEDLEY signals (C-MEDLEY and R-MEDLEY) with gain corrections, it is possible to improve the B&G value that is determined by increasing the gain for the high frequency range in advance when exchanging the MEDLEY signals, and to provide a high speed communication.

FIG. 8 illustrates a configuration of a modem section of the ADSL communication apparatus of the center and remote sides. The modem section of the ADSL communication apparatus is connected to line 1 via analog front end (AFE) 70. Analog front end (AFE) 70 has a DA conversion function that converts digital signals transmitted to uplink into analog signals, and AD conversion function that converts analog signals input from downlink into digital signals. The sender side has super frame CRC adder 71 that adds a check bit in front of a super frame, scrambler/FEC/interleave 72 that performs a scramble process spreading the transmission frequencies, forward/error/correction process adding symbols for correcting errors, and interleave process, tone ordering unit 73 that performs tone ordering process controlling the carrier ordering for bit allocation, constellation encoder 74 that converts symbols into topology information on an I-Q plane with a predetermined bit unit, and inverse fast Fourier transformer 75. The receiver side has fast Fourier transformer 76 that performs a fast Fourier conversion on the reception signals output from analog front end 70, constellation decoder 77 that converts the topology information on the I-Q plane output for every carrier from fast Fourier transformer 76 into bit information, tone de-ordering unit 78 that rearranges the signals in the original positions after the tone ordering process at the sender side, de-scrambler/de-FEC/de-interleave unit 79 that rearranges the scramble process, forward/error/correction process, and interleave process performed at the sender side, and super frame CRC check unit 80 that checks the reliability of the data after examining the check bit added in front of the super frame.

The sequence illustrated in FIG. 1 is performed by a controller (not shown) that controls the various functions as described above at both sender and receiver side. The controller can be composed by the DSP.

In the above explanation, the difference from the highest value of the reception level is used as carrier gain correction value, however, if the highest value of the reception level is rather low, off set value can be added to the carrier gain correction value.

Also, in the above explanation, the receiver side calculates the carrier gain correction value of the sender side, to make a request to the sender side, however, the receiver side can inform the sender side of only the decay rate data of each carrier, and the sender side can calculate the gain correction value from the decay rate data.

Also, in the above explanation, the sender side is informed of all the carrier gain correction values, however, the sender side can be informed of only the carrier in which the decay rate is greater than a predetermined value as a sub-carrier for correction, and calculate the gain correction value according to the decay rate for the sub-carrier for correction.

Further, in the above-explanation, illustration is done when the present invention is applied to an ADSL communication apparatus, however, this invention can be applied to any xDSL apparatuses provided that they use the communication method performing an initialization sequence after performing a handshake step.

The present invention is not limited to the above-described embodiments, and various variations and modifications may be possible without departing from the scope of the present invention.

This application is based on the Japanese Patent Application No. 2001-279555 filed on Sep. 14, 2001, entire content of which is expressly incorporated by reference herein.

What is claimed is:

1. A communication control method comprising:
connecting a line between two communication control apparatuses;
performing an initialization sequence setting a transmission speed;
detecting gain characteristics of a signal received during the initialization sequence;
informing each other of the detected gain characteristics; and
correcting gain characteristics of a future transmission signal based on the gain characteristics informed by a partner communication control apparatus.

2. The communication control method according to claim 1, wherein the initialization sequence and a data communication performed thereafter employ a communication method in which plurality of carriers are simultaneously used, and the gain characteristics are detected for each carrier.

3. The communication control method according to claim 1, wherein the initialization sequence includes a step for exchanging REVERB signals and a step for exchanging MEDLEY signals thereafter, and detects gain characteristics of the REVERB signals.

4. The communication control method according to claim 3, wherein the gain characteristics of the REVERB signals are detected in order to add a gain correction to a signal after the MEDLEY signals.

5. The communication control method according to claim 1, wherein a handshake step is performed prior to the initialization sequence in order to agree to execute original procedure performing a gain correction by detecting gain characteristics in the initialization sequence.

6. A communication control apparatus comprising:
a handshake controller that connects a line with a communication control apparatus on other side, performs a handshake procedure to inform the communication control apparatus on other side of performing an initialization sequence setting a communication speed;
an initialization sequence controller that performs the initialization sequence with the communication control apparatus on other side;
a detector that detects gain characteristics of a signal received during the initialization sequence; and
a notification unit that informs the partner communication control apparatus of the detected gain characteristics.

7. The communication control apparatus according to claim 6, wherein said detector detects gain characteristics for each carrier.

8. The communication control apparatus according to claim 6, wherein said detector detects gain characteristics of a REVERB signal

9. The communication control apparatus comprising:
a handshake controller that connects a line with a communication control apparatus on other side, performs a handshake procedure to inform the communication control apparatus on other side of performing an initialization sequence setting a communication speed;
an initialization sequence controller that performs the initialization sequence with the communication control apparatus on other side; and
a correction unit that performs a gain correction on a transmission signal based on informed gain characteristics, when gain characteristics of the transmission signal is notified from the partner communication control apparatus during the initialization sequence.

10. The communication control apparatus according to claim 9, wherein said initialization sequence controller performs a step for exchanging REVERB signals and a step for exchanging MEDLEY signals thereafter, and performs a gain correction on a signal after the MEDLEY signals.

11. The communication control apparatus according to claim 6, wherein said handshake controller informs the communication control apparatus on other side of performing an original procedure including a procedure which detects gain characteristics of a reception signal to perform a gain correction on a transmission signal during the handshake procedure, as the initialization sequence.
